(19) United States
(12) Patent Application Publication
(10) Pub. No.: US 2025/0202879 A1
(43) Pub. Date: Jun. 19, 2025

(54) SELECTIVE SAMPLING OF COMMUNICATION CHANNEL FOR IDENTIFYING SENDER

(71) Applicant: The Regents of the University of Michigan, Ann Arbor, MI (US)

(72) Inventor: Hafiz M.A. MALIK, West Bloomfield, MI (US)

(21) Appl. No.: 18/981,527

(22) Filed: Dec. 14, 2024

Related U.S. Application Data
(60) Provisional application No. 63/610,402, filed on Dec. 14, 2023.

(51) Int. Cl. H04L 9/40

(52) U.S. Cl. CPC H04L 63/08

(57) ABSTRACT

An electronic control unit (ECU) authentication system and method for determining an identity of a sender of a message over a physical channel, where the ECU authentication system is configured to perform the method. The method includes: generating distortion data based on a data transmission signal sent over a physical channel through selectively sampling the data transmission signal, wherein selectively sampling the data transmission signal includes sampling the data transmission signal at a first sampling rate and sampling the data transmission signal at a second sampling rate that is different than the first sampling rate; and identifying a sender of the data transmission signal based on the distortion data.

### GOVERNMENT FUNDING

This invention was made with government support under 2035770 awarded by the National Science Foundation. The government has certain rights in the invention.

### TECHNICAL FIELD

This invention relates to signal transmission sender identification and, more particularly, to identifying senders based on unique, minor variations in transmission signals sent over an electronic data communications bus, network, or other physical channel of a electronic data communications medium.

### BACKGROUND

Certain network communication protocols or implementations, such as controller area network (CAN) based systems, lack authentication in terms of authenticating the sender of the transmission/message. For example, CAN, which is a message-based protocol and is vastly used in the automotive industry due to its ability to construct an inexpensive and faster network, lacks an authentication scheme, making modern vehicles and other devices using CAN open to different kinds of spoofing attacks. There is ample evidence in the literature of taking control of vehicles remotely, which poses serious threat and can harm passengers and pedestrians. Although several mitigation strategies have been proposed in order to identify the senders, high computational costs have hindered their applicability in practice.

One of the most popular in-vehicle networking protocols, CAN, was first introduced by Robert Bosch™ GmbH in 1983 and became a defacto protocol for in-vehicle communications primarily due to two specific reasons: first, by design, the protocol is applicable for hard real-time environments that guarantee communication with minimal time latency, with “hard” referring to hard limits on message time in that if the message arrival time is over this limit, the message cannot be delivered or accepted by the receiver; and, second, it reduced the wiring problem of a vehicle and was able to reduce the cost of vehicle manufacturing. These reasons are why the CAN bus protocol is used in essentially all modern vehicles as the backbone of in-vehicle network communication.

By default, the CAN protocol is broadcasting in nature, which means messages that are sent to the bus are accessible by all the entities connected to the network. It brings simplicity in terms of design, but on the other hand the simplistic design can be leveraged by hackers, as it lacks a basic security feature (i.e. implementation of a message authentication mechanism which makes it vulnerable to a variety of spoofing attacks). In a single CAN message packet, a field that holds information of the source is absent. Because of the absence of the sender information, any electronic control unit (ECU) on the network can impersonate other ECUs in the network. An adversary can leverage that vulnerability of this protocol to launch various attacks leading to malfunctioning of the vehicle.

For example, in 2015, two individuals remotely took control of a vehicle by injecting CAN data in the network. Surprisingly, the vehicle could not differentiate the impersonating CAN message and moved into a ditch. Another demonstration was shown by the Keen Security Lab of Tencent™ team in 2016 in which researchers remotely controlled a Tesla Model S™. The researchers have gained entrance remotely by using Wi-Fi/cellular as a back-door and was able to compromise many in-vehicle systems like instrument cluster (IC), central information display (CID), and gateway. Moreover, the team injected a malicious CAN message into the network. In December 2019, a gray-hat hacker created an android application that used an Arduino™ microcontroller in order to inject a CAN message into a Mercedes™ vehicle. The basic functionality of the application was to add features such as locking and unlocking doors, display custom text in instrument cluster, control hazard light etc. This clearly indicates that the researchers took advantage of a known weakness of CAN protocol to spoof the network, namely the absence of source identification field.

To solve the above-mentioned security vulnerability, different approaches have been implemented by the security researchers. These solutions can be broadly categorized into two categories: (1) cryptography based solutions; and (2) intrusion detection system based solution. The traditional cryptography-based solutions can provide some degree of security, but they are computationally expensive and uses the network bandwidth which is critical for CAN based vehicle networks. Moreover, these cryptography based solutions are vulnerable to replay attack. Recently, researchers have proposed intrusion detection system based solutions for detecting CAN cyberattacks by implementing physical layer identification techniques. The fundamental idea of this approach is that the analog signal behaviors of data transmitters has slight variations which are introduced in the design, fabrication and manufacturing process. Researchers show that even manufactured in the same production lot, two same digital devices have unique artifacts in their signaling behavior, which is difficult to control and duplicate. Avatefipour et al. (Avatefipour, O., Hafeez, A., Tayyab, M., & Malik, H. (2017 December). Linking received packet to the transmitter through physical-fingerprinting of controller area network. In 2017 IEEE Workshop on Information Forensics and Security (WIFS) (pp. 1-6). IEEE) was able to extract those unique artifacts and proposed a framework based on neural network for CAN sender identification by utilizing the extracted distortions. Likewise, in the last 5 years, researchers have proposed a lot of frameworks that are effective in CAN transmitter identification.

The proposed transmitted identification method in Avatefipour et al. relies on the fact that each electronic device (e.g., ECU) and channel impulse response of the physical channel (e.g., CAN-Bus) exhibit unique artifacts which can be used for linking received signal to the sending ECU. More specifically, by extracting the distinguishable statistical features of transmitting signals, the source of the coming message is identified.

Let Sᵢ(t) be the output of the i^{th} ECU and hⱼ(t) be the impulse response of the j^{th} physical channel between the i^{th} ECU and the physical fingerprinting (PhyFin) unit. The physical signal at the input of the PhyFin unit, yᵢⱼ(t), can be expressed in Equation 1, respectively.

$${y}_{i j} ( t ) = {h}_{j} ( t ) * {S}_{i} ( t )$$

where, * denotes convolution operator

### Equation (1)

Physical signal at the input of PhyFin unit, yᵢⱼ(t) is used for linking the signal to its source.

Although the proposed method in Avatefipour et al. works well for sender/transmitter identification, the processing costs are high, making real-time sender identification challenging.

### SUMMARY

In accordance with a first aspect of the invention, there is provided a method of determining an identity of a sender of a message. The method includes: generating distortion data based on a data transmission signal sent over a physical channel through selectively sampling the data transmission signal, wherein selectively sampling the data transmission signal includes sampling the data transmission signal at a first sampling rate and sampling the data transmission signal at a second sampling rate that is different than the first sampling rate; and identifying a sender of the data transmission signal based on the distortion data.

The method of the first aspect may further include any of the following features or any technically-feasible combination of two or more of the following features:
first portion sampled data is generated based on the data transmission signal through sampling the data transmission signal at the first sampling rate, wherein second portion sampled data is generated based on the data transmission signal through sampling the data transmission signal at the second sampling rate, and wherein the distortion data is generated based on the first portion sampled data and the second portion sampled data;
the first portion sampled data of the data transmission signal and the second portion sampled data of the data transmission signal each oscillates about a target voltage;
the first portion sampled data of the data transmission signal is an overshoot portion of a bit of data being conveyed by the data transmission signal;
the second portion sampled data of the data transmission signal is a portion of the bit of data that the first portion sampled data of the data transmission signal is a part of;
a first portion of the data transmission signal is sampled at the first sampling rate to obtain the first portion sampled data and is an information-dense portion, and wherein a second portion of the data transmission signal is sampled at the second sampling rate and is an information-sparse portion;
the second sampling rate is one-half or less the first sampling rate;
the second sampling rate is one-fifth or less the first sampling rate;
the first sampling rate is sampled from a portion of the data transmission signal corresponding to a single bit, and wherein the second sampling rate is sampled from the portion or other portion of the data transmission signal corresponding to the single bit;
the distortion data is used to generate a distortion image, and wherein the sender is identified based on the distortion image;
the distortion image is a recurrence plot representing recurring patterns observed in data transmission signals transmitted by the sender;
the recurrence plot is matched to a representative distortion image in order to identify the sender, and wherein the representative distortion image is one of a plurality of predetermined representative distortion images; and/or
each of the plurality of predetermined representative distortion images corresponds to a separate sender of a plurality of senders including the sender.

According to a second aspect of the invention, there is provided an electronic control unit (ECU) authentication system for authenticating transmission signals carrying data over a communications network. The ECU authentication system includes at least one electronic processor and memory storing computer instructions accessible by the at least one processor. The ECU authentication system is configured, as a result of executing the computer instructions using the at least one processor, to: sample a data transmission signal at a first sampling rate to obtain first portion sampled data; sample the data transmission signal at a second sampling rate to obtain second portion sampled data, wherein the first sampling rate is different than the second sampling rate; and identify a sender of the data transmission signal based on the first portion sampled data and the second portion sampled data.

The ECU authentication system of the second aspect may further include any of the following features or any technically-feasible combination of two or more of the following features discussed above in connection with the method of the first aspect.

According to a third aspect of the invention, there is provided an ECU having the ECU authentication system of the second aspect.

According to a fourth aspect of the invention, there is provided an ECU authentication system for authenticating transmission signals carrying data over a communications network. The ECU authentication system includes: a first ECU having at least one processor and memory storing computer instructions; a second ECU; and a communications network for providing a physical channel for carrying a data transmission signal from the second ECU to the first ECU. The ECU authentication system is configured, as a result of executing the computer instructions using the at least one processor, to: sample the data transmission signal at a first sampling rate to obtain first portion sampled data; sample the data transmission signal at a second sampling rate to obtain second portion sampled data, wherein the first sampling rate is different than the second sampling rate; and identify a sender of the data transmission signal based on the first portion sampled data and the second portion sampled data.

The ECU authentication system of the fourth aspect may further include any of the following features or any technically-feasible combination of two or more of the following features discussed above in connection with the method of the first aspect.

The ECU authentication system of the fourth aspect may further include any of the following features or any technically-feasible combination of two or more of the following features:
the physical channel is provided by a controller area network (CAN), and wherein the first ECU and the second ECU are installed on a vehicle having a communications network including the physical layer;
the second ECU has at least one processor and memory storing computer instructions, and wherein the second ECU is configured, when executing the computer instructions of the second ECU using the at least one processor of the second ECU, to: sample a second data transmission signal at a third sampling rate to obtain third portion sampled data; sample the second data transmission signal at the fourth sampling rate to obtain fourth portion sampled data; and identify a sender of the data transmission signal based on the third portion sampled data and the fourth portion sampled data, wherein the third sampling rate is different than the fourth sampling rate; and/or
the third sampling rate is the same than the first sampling rate, and wherein the second sampling rate is the same as the fourth sampling rate.

According to another aspect of the invention, there is provided a vehicle communications network having the ECU authentication system of the second aspect or the fourth aspect.

### BRIEF DESCRIPTION OF THE DRAWINGS

Illustrative embodiments will hereinafter be described in conjunction with the appended drawings, wherein:

FIG. 1 is a block diagram depicting an electronic communications system having a sender, receiver, and an ECU authentication system, according to one embodiment;

FIGS. 2A-C depict is a schematic diagram of an exemplary controller area network (CAN) based communications system having three ECUs, and demonstrating a spoofing attack, according to one embodiment;

FIG. 3 is a flowchart illustrating a method of determining an identity of a sender of a message, according to one embodiment;

FIG. 4 is a voltage time-series graph illustrating two data transmission signals, according to one embodiment;

FIG. 5 is a voltage time-series graph illustrating a data transmission signal and an ideal or target CAN-H signal, according to one embodiment;

FIG. 6 is a graph illustrating a voltage time-series for a data transmission signal, according to one embodiment; and

FIG. 7 includes graphs illustrating physical layer orientation of the OSI model for CAN protocol signaling.

### DETAILED DESCRIPTION

The system and method described herein enables identifying a sender of a data transmission signal sent over a physical channel through extracting distortion data from the data transmission signal. The distortion data (or extracted distortion data) is data representing values derived from samples of the data transmission signal, which is an analog signal, and the distortion data is separate than the data encoded within the data transmission signal. Namely, at least in embodiments, the distortion data is data indicative of signal variances relative to a target signal path or attribute values, such as variances in voltage relative to a target voltage. The distortion data is used to identify and verify the authenticity of the data transmission signal through generating a signature and comparing the signature to a predetermined signature for the ECU, which may be determined and stored at the system ahead of time, at least according to some embodiments.

According to embodiments, the distortion data is generated by selectively sampling the data transmission signal. As used herein, “selectively sampling” and its various forms means sampling a first portion (sometimes referred to as a first rate portion) of a data transmission signal at a first sampling rate and a second portion (sometimes referred to as a second rate portion) of the data transmission signal at a second sampling rate, where the second portion is temporally distinct from the first portion. As used herein, “temporally distinct” for a first portion and a second portion means the first portion is temporally defined by a first time period that does not coincide with a second time period that temporally defines the second portion. As used herein, when “temporally define” or one of its various forms is used in connection with a portion of a data transmission signal, such as where the portion is said to be “temporally defined” by a time period or where a time period is said to “temporally define” the portion, the portion is the data transmission signal during the time period. Data sampled within the first time period is referred to as “first portion sampled data” and, likewise, second time period is referred to as “second portion sampled data”. Sampling at different rates for different portions may provide for improved usage of resources, as a selective sampling configuration process aids in providing selective sampling parameters usable during real-time authentication of data transmission signals being sent by ECUs. In embodiments, the selective sampling configuration process analyzes images generated from distortion data for an ECU where the distortion data is sampled according to a plurality of different selective sampling parameters—this enables the authentication results from each of the differently-sampled distortion data to be compared in terms of validation accuracy and processing time. Then, according to the results and requirements/specifications sought for the implementation that is to be used, selective sampling parameters are selected for use in verifying the origin of the data transmission signal in real-time thereby enabling low-latency, real-time authentication of data transmission signals.

In some embodiments, the first portion corresponds to an information-dense portion of the data transmission signal, and the second portion corresponds to an information-sparse portion of the data transmission signal. In such embodiments, the first portion sampled data is also referred to as “information-dense distortion data”, and the second portion sampled data is also referred to as information-sparse distortion data”. Further, in at least some of embodiments, the distortion data includes the information-sparse distortion data and the information-dense distortion data. As used herein, an “information-dense portion” of the data transmission signal corresponds to a portion of the data transmission signal that oscillates about a target voltage with an amplitude (also referred to as an “oscillating amplitude”) that is at least a predetermined overshoot threshold (e.g., thirty percent (30%)) of a maximum amplitude of the data transmission signal about the target voltage (also referred to as an “overshoot portion”). As used herein, “target voltage” means a voltage about which a data transmission signal oscillates, such as 2.5 volts (V) for a recessive bit and 3.5 V for a dominant bit in a CAN-based implementation. As used herein, “overshoot portion” means a portion of a data transmission signal that oscillates about a target voltage with an amplitude (also referred to as an “oscillating amplitude”) that is at least a predetermined overshoot threshold (e.g., thirty percent (30%)) of a maximum amplitude of the data transmission signal about the target voltage. In embodiments, an overshoot portion exists for each bit output as an analog signal representing the data transmission signal—such an embodiment is an example of “bit-wise selective sampling”, which, as used herein, means selectively sampling where the first portion and the second portion each form a part of a single bit of data. The bit may be a dominant bit or a recessive bit of a CAN data transmissional signal, for example. The predetermined overshoot threshold is thirty percent (30%) of the maximum amplitude of the data transmission signal about the target voltage, such as 50%, 25%, 20%, 15%, 10%, or 5%, for CAN-based implementations, for example. In embodiments, the predetermined overshoot threshold is determined based on which portions of the data are to be sampled at which rates, such as sampling an overshoot portion (or portion at or greater than the predetermined overshoot threshold) at a different rate than sampling other portions of the data transmission signal.

In some embodiments, the distortion data sampled from the data transmission signal is used to generate an image, which may be a recurrence plot (RP), at least in some embodiments. The image is then input into a deep neural network, which generates an output indicating an identity of the sender of the data transmission signal. In embodiments, the distortion data for a data transmission signal is transformed into recurring distortion data by generating a recurrence plot based on the data transmission signal whereby the recurrence plot is a two dimensional image, correlation table, matrix, or other suitable representation that identifies recurring patterns within the data transmission signal, particularly within distortion data of the data transmission signal.

More discussion regarding the target voltage, the oscillating amplitude, the maximum amplitude, the information-dense portion, and the information-sparse portion is provided below, along with an example used as a part of an exemplary CAN-based embodiment.

Below, there is provided an embodiment in which data transmission signals are transmitted using a controller area network (CAN) bus that uses an analog signal (the data transmission signal) to generate dominant and recessive bits in order to convey information. Background of CAN is presented below in order to facilitate illustration of the method and system provided herein, at least according to embodiments, particularly CAN-based embodiments.

To highlight the overview of CAN protocol, the protocol characteristics and its representation in terms of Open Systems Inter-connection model (OSI model) is described here. Moreover, the security issues originated from the basic architectural design of the protocol is described below.

By design the controller area network (CAN) is a broadcasting protocol where ECUs communicate with each other using a single wire. This enables the system manufacturer to reduce complex wiring design of many point to point connections between ECUs and make the system easily maintainable. While connected to a standard CAN network, an ECU can send 0-8 bytes of data with an eleven bit identifier. The identifier is used for the priority scheme of CAN protocol which is that messages with lower arbitration ID have high priority while going through the bus. On the other hand, any entity connected to the bus can listen to all the traffic in the network for its broadcasting nature.

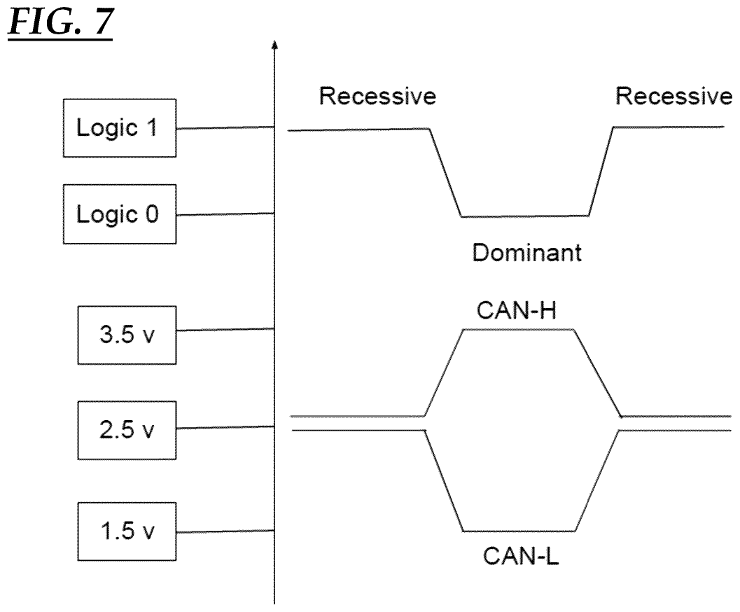

The CAN protocol is specified in International Organization for Standardization (ISO) 11898 and is defined in the physical layer and data link layer of the Open Systems Interconnection (OSI) model. In the CAN physical layer, the data is handled as binary bits and the core functionality of this layer is to ensure bit encoding/decoding, bit synchronization and indicate physical wire orientation and on the other hand, CAN data link layer handles CAN data as frames and performs complex tasks like data encapsulation, frame encoding, frame error detection. Physically, the CAN bus is actually a twisted pair wire, terminated with 120 ohm. The twisted pair is called the CAN high (CAN-H) and the CAN low (CAN-L) and provides protection against electromagnetic interference. In terms of physical layer orientation of OSI model, CAN protocol follows differential signaling (shown in FIG. 7) where the final voltage of a single bit data is extracted by subtraction between CAN-H and CAN-L. When there is a 0 bit in the bus (dominant bit), CAN-H pulls 3.5 V where CAN-L contains 1.5 V. In terms of a bit with value 1 (recessive), CAN-H and CAN-L both set the voltage to 2.5 V.

In data link layer, a CAN protocol handles data as frames. By default a standard CAN packet has 108 bits in total as shown in Table 1. It starts with a single bit of data called start of frame (SOF) field. Then it is followed by 11 bit arbitration ID (AID), 1 bit remote transmission request (RTR), 6 bit control field, 0-64 bits of data field, 16 bits cyclic redundancy check (CRC), 2 bits acknowledgment (ACK) field, 7 bits of end of frame (EOF) field. While connected in a communications network, an ECU can send a CAN packet to the traffic by sending a CAN data frame by putting dominant bit in the RTR field and an ECU can request data from another ECU by sending a CAN remote frame with a recessive bit in the RTR field. Although there is an AID field presented in a CAN packet, there is not a single field available that indicates the source address. There is CRC field in a CAN packet which only protects the data field. So, the absence of source field and the broadcasting nature of the protocol clearly indicates that the CAN protocol lacks one of the concepts of the famous CIA triad (confidentiality, integrity, and availability). According to embodiments, the system and method operate to identify senders thus ensuring integrity.

TABLE 1
A standard CAN data packet

| Field name | Number of bits |
|---|---|
| Start of frame | 1 |
| Arbitration ID | 11 |
| Remote transmission request | 1 |
| Control fields | 6 |
| Data field | 0-64 |
| Cyclic redundancy check (CRC) | 16 |
| Acknowledgement | 2 |
| End of frame | 7 |
| Total | 108 |

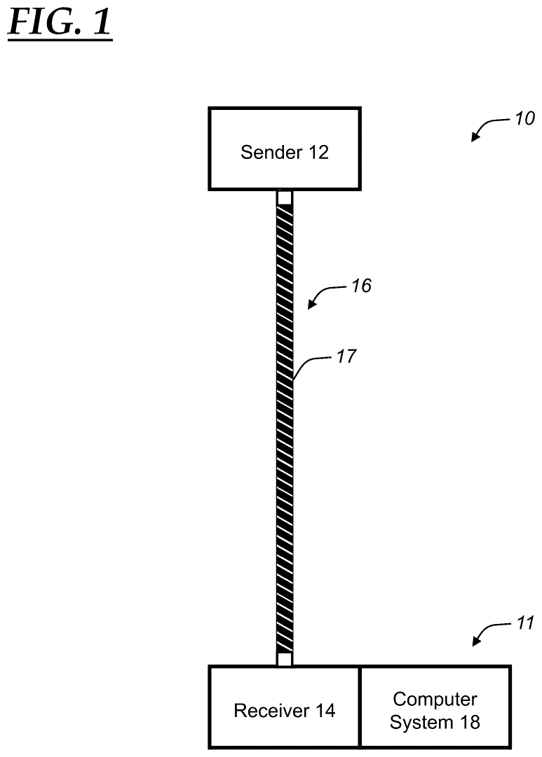

With reference to FIG. 1, there is shown an embodiment of an electronic communications system 10, which includes a sender or transmitter electronic control unit (ECU) (or “sender”) 12, a receiver ECU (or “receiver”) 14, a communications network 16 over which data transmission signals are transmitted from the sender 12 to the receiver 14, and a computer system 18. In the present embodiment, the communications network 16 is illustrated as including a physical channel implemented as a CAN bus 17 implemented via twisted pair wiring, as illustrated in FIG. 1. The receiver 14 and the computer system 18 are used to identify the sender of data transmission signals sent over the communications network 16 and, together, the receiver 14 and the computer system 18 may be referred to as an ECU authentication system 11. The ECU authentication system 11 is shown in the illustrated embodiment as being located at and directly (i.e., via wire, bus, like hardware, or dedicated wireless channel therebetween) connected to the receiver 14. The ECU authentication system 11 executes the method described herein in order to identify the sender of a data transmission signal sent over the communications network 16, and this functionality may be effected by executing the computer instructions, so configured to perform the method as described herein, in order to process the data transmission signal to identify the sender. In embodiments, one or more instances of an ECU authentication computer program are used (ECU authentication instance) for identifying a sender for each (or at least a set) of data transmission signals received at the receiver 14. However, it will be appreciated that the ECU authentication system 11 may include components located remotely from the receiver 14, such as a secondary computer system for supporting the ECU authentication system 11 (e.g., providing updated parameters for the method or other processing).

The sender 12 is an ECU that transmits data transmission signals to the receiver 14, and these data transmission signals may be received at the receiver 14. The receiver 14 may then process the data transmission signals in order to identify the sender 12 of the data transmission signals. The identity of the sender of the data transmission signal can be used to ensure that the received message (as encoded in the data transmission signal) is authentic and not a part of a spoofing attack, for example. The sender 12 may also receive data transmission signals via the communications network 16, effectively operating also as a receiver. Likewise, receiver 14 may also send or transmit data transmission signals via the communications network 16, effectively operating also as a sender. Furthermore, any number of other ECUs may participate in the communications network as a sender and/or receiver, according to embodiments.

In embodiments, the sender 12 includes a microcontroller or a dedicated controller, such as the MCP2515 from Microchip Technology™, which is a dedicated CAN controller. This element governs the CAN protocol, ensuring both the sending and receiving of CAN frames are executed properly. The sender 12 may include a transceiver, which operates to transmit data transmission signals over a communications medium, such as a CAN bus, which may be hardwired and the physical bus. The TJA1050 from NXP Semiconductors™ is a notable example of this transceiver. It has the dual role of transforming digital messages from the controller into differential voltage signals suited for the CAN bus and doing the reverse as well. Augmenting these components is the oscillator or crystal, which furnishes a clock source vital for the system's timing and synchronization. Given that the CAN protocol demands impeccable timing for activities like bit sampling and error detection, the inclusion of such an oscillator becomes indispensable for the seamless function of the ECU.

The receiver 14 is an ECU that receives data transmission signals from the sender 12, and potentially from other ECUs participating in the communications network 16. In embodiments, the communications network 16 is a CAN-based communications network, which is a communications network that uses CAN to facilitate communication between various components, such as sensors, actuators, and control modules, within systems like, but not limited to, various vehicle systems, such as a vehicle's braking system, engine management, airbag deployment, and infotainment, among other applications. In embodiments using a CAN-based communications network, the sender 12 and the receiver 14 are connected via a CAN bus over which data transmission signals are transmitted. The CAN-based communications network may use any of a variety of different CAN bus variants, including High-Speed CAN, Low-Speed/Fault-Tolerant CAN, and CAN FD, for example, may be used for the CAN bus 17. Also, in CAN-based implementations, the physical layer utilizes differential signaling via CAN-H and CAN-L lines, typically transmitted over shielded or unshielded twisted pair wires. In other embodiments, the communications network 16 may be implemented using other protocols or technologies, such as LIN (Local Interconnect Network). LIN also often serves as a communication protocol for automotive systems and, like CAN, LIN uses voltage levels for encoding, although it typically operates at a lower data rate and is often used for simpler, non-critical applications within the vehicle, such as window controls or ambient lighting.

The computer system 18 is used to perform a process or method in order to identify a sender of a data transmission signal, and this process may be repeated any desired number of times, such as for each message transmitted over the communications network 16, for example. The computer system 18 includes at least one processor and memory storing computer instructions that, when executed by the at least one processor, cause the computer system 18 to perform the method described herein, such as in order to identify the sender of each of the data transmission signals transmitted over the communications network 16. The computer system 18 is shown as being local to the receiver 14, as the computer system 18 uses the data transmission signal to identify the sender. In embodiments, the computer system 18 may be integrated into a controller of the receiver 14, such as a CAN controller.

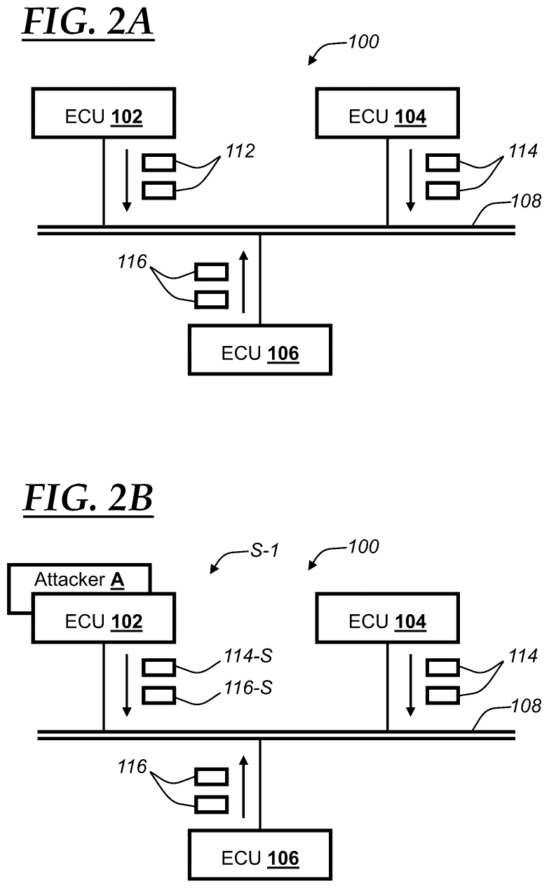

With reference to FIGS. 2A-C, consider a CAN network 100 having three ECUs 100, 102, 104 as shown, and these figures are useful in demonstrating a spoofing attack. As mentioned above, due to the absence of sender or receiver address as discussed above, CAN network is susceptible to spoofing attack. The attack can be defined as when a compromised ECU tries to send CAN data by impersonating an authorized ECU with the same or different CAN AID. In a modern vehicle, this can happen two different ways. One way is when an attacker takes control of an authorized ECU utilizing its code vulnerabilities whereby the compromised ECU is able to impersonate any other ECU connected to the network. And the other way is when an attacker gains access to the vehicle by external connectivity (e.g. via OBD-II port or using Wi-Fi™ or Bluetooth™). It is a feasible attack example because having OBD-II ports included in the vehicle is a standard in the automotive industry, with pin “6” (the sixth pin) and pin “14” (the fourteenth pin) representing the CAN interface that can be used to connect external devices.

FIG. 2A depicts a computer system 100 with three ECUs 102, 104, 106 that are communicatively coupled via the communications network 108, which is analogous to the communications system 16 discussed above. Further, each of the three ECUs 102, 104, 106 may be a sender, a receiver, or both, as the discussion of the sender 12 and the receiver 14 is analogous to the ECUs 102, 104, 106 when being used in such a capacity (as sender, receiver, or both). Each of the ECUs 102, 104, 106 is shown as transmitting a data 112 in the form of a data transmission signal, such as through using a CAN-based communications network for the network 108.

FIG. 2B depicts the computer system 100 of FIG. 2A, under a first spoofing scenario S-1 where an attacker A carries out a spoofing attack in which the attacker A takes control of ECU 102 and is trying to spoof/impersonate ECUs 104, 106 through issuing spoofed messages 114-S, 116-S, corresponding to a spoofed message of the second ECU 104 and third ECU 106, respectively.

FIG. 2C depicts the computer system 100 of FIG. 2A, under a second spoofing scenario S-2 where an attacker A carries out a spoofing attack in which the attacker A gains access to the communications network (e.g., the CAN bus) as an external entity that impersonates the second and third ECUs 104 and 106 through issuing spoofed messages 114-S′, 116-S′, corresponding to a spoofed message of the second ECU 104 and third ECU 106, respectively. The spoofed messages 114-S, 114-S″, 116-S, 116-S′ may have an arbitration id and data payload that impersonates the ECU 104, 106.

To help ensure integrity in the CAN bus, one approach is to implement message authentication scheme by including a message authentication code (MAC) inside CAN frame. While it makes the CAN bus secure but according to the standards, the least size of the MAC is 64 bit to prevent collisions. So, the challenge of implementing the MAC based approaches is to add 64 bit MAC along with the data that needs to be transported to the network where the data field can only hold up to 64 bits of data 1. To overcome the approach, researchers proposed two kind of MAC implementations: one is, instead of using 64 bit MAC, using a truncated MAC to include integrity to CAN protocol; and the other approach is to use CAN+ protocol, an improvement of the existing CAN where additional data can be sent in time intervals to authenticate CAN messages. For example, researchers in crafted a 4 byte MAC and put it into the data field of the CAN packet to authenticate CAN message. The disadvantage of truncating CAN data field to include MAC is it limits the size of data payload to be transmitted in a CAN packet and restricts the CAN protocol to transmit 8 bytes data payload. The proposed works send two CAN messages where one contains the data payload the other one contains the MAC address. The approach resolves the issues originated by the truncated MAC approaches but it uses the limited traffic bandwidth of CAN network (1 Mbit/s) as it needs to send two packets of data to securely send a single CAN data payload.

Apart from the CAN message authentication techniques, researchers have considered to fingerprint CAN senders by using physical unclonable characteristics such as clock skews and voltage. The main idea of this approach is to identify the source of CAN transmitters. The concept is adopted from the famous physical layer identification (PLI) technique where the unique characteristics of transmitters are extracted to link the physical signals to the senders. The techniques for CAN PLI can be classified into two categories: clock skew based fingerprinting; and voltage based fingerprinting.

Clock skew based fingerprinting: The quartz crystal clock determines the different clock frequencies on an ECU, resulting in random clock drifts which can be used to uniquely identify an ECU. Cho and Shin proposed a Clock-based IDS (CIDS) which exploits the intervals of periodic message to estimate the clock skews as the fingerprint of the transmitter ECU. The idea was used to estimate clock behaviors of ECUs to detect the intrusion and identify the source of the message. However, this method is effective in a temperature-stable environment.

Voltage-based fingerprinting: Authenticating the CAN message transmitter based on the unique and immutable physical characteristics such as the voltage, is termed as physical fingerprinting. Researchers in Avatefipour et al. extracted time domain and frequency domain statistical features using voltages captured from the ECUs and proposed a neural network-based ECU classifier, and achieved an accuracy of 98.3% on an experimental setup using microcontrollers. Others have proposed an edge-based identification method using voltage collected using picoscope (software defined oscilloscope) and a naive bayes classifier. As a feature they used statistical time domain features such as mean, variance, skewness, kurtosis, radio max plateau, plateau, overshoot height, irregularity, centroid, flatness, power and maximum.

The research works described above achieved high accuracy in identifying CAN signal senders, but the feature extraction is highly expensive in terms of computational complexity. Table 2 represents the common statistical features and their corresponding computational cost. To overcome this, the system and method herein, at least according to some embodiments, eliminates the necessity of extracting highly computational statistical features described above by utilizing images generated from the uniqueness presented in the voltage data to identify CAN signal transmitter. The image is generated using recurrence plot method whose computational complexity is Θ(n²) whereas the computational complexity of any framework that uses feature shown in Table 2, is 3*(Θ(n²)+Θ((n)). Experimental results show that the proposed framework processes features to identify ECUs with a lower computational time than the state-of-the-art work.

TABLE 2
Computational complexity of common state-of-the-art statistical features

| Feature Name | Equation | Time complexity |
|---|---|---|
| Minimum | min = min(xᵢ) | Θ(n) |
| Maximum | max = max(xᵢ) | Θ(n) |
| Mean | $\overline{x} = \frac{{\sum }_{i = 1}^{n} {x}_{i}}{n} = \frac{{x}_{1} + {x}_{2} + … + {x}_{n}}{n}$ | Θ(n) |
| Variance | ${s}^{2} = \frac{{\sum }_{i = 1}^{n} {( {x}_{i} - \overline{x} )}^{2}}{n - 1} = \frac{{\sum }_{i = 1}^{n} {x}_{i}^{2} - n {\overline{x}}^{2}}{n - 1}$ | Θ(n²) |
| Skewness | $skewness = \frac{{\sum }_{i = 1}^{n} {( {x}_{i} - \overline{x} )}^{3}}{( n - 1 ) * {σ}^{3}}$ | Θ(n²) |
| Kurtosis | $kurtosis = \frac{{μ}_{4}}{{σ}^{4}}$ | Θ(n²) |

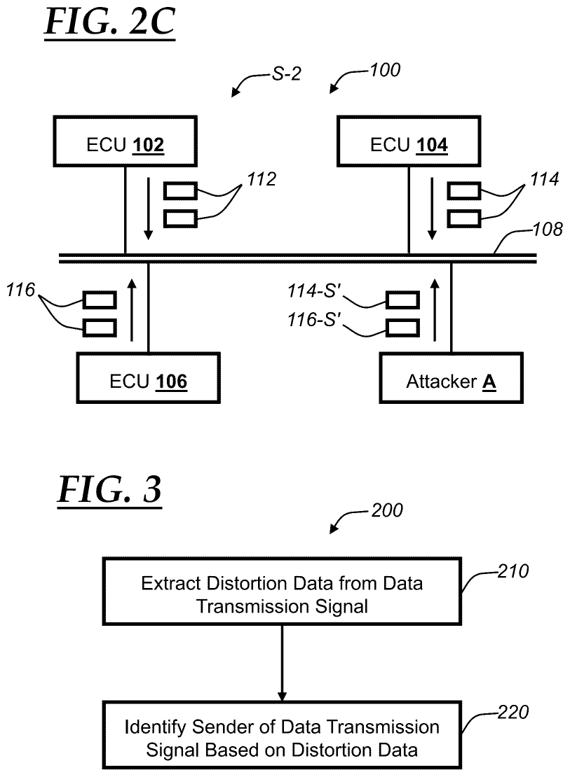

With reference to FIG. 3, there is shown a method 200 of determining an identity of a sender of a message. The method 200 is performed by the computer system ECU authentication system 11, particularly the computer system 18, at least in embodiments.

The method 200 begins when a data transmission signal is received. The data transmission signal is an analog signal that is used to encode data, such as for conveying messages or information. In embodiments, the data transmission signal is formed as a series of voltage differentials relative to one or more predefined voltage levels, such as the three CAN levels (1.5 V, 2.5 V, 3.5 V) discussed above.

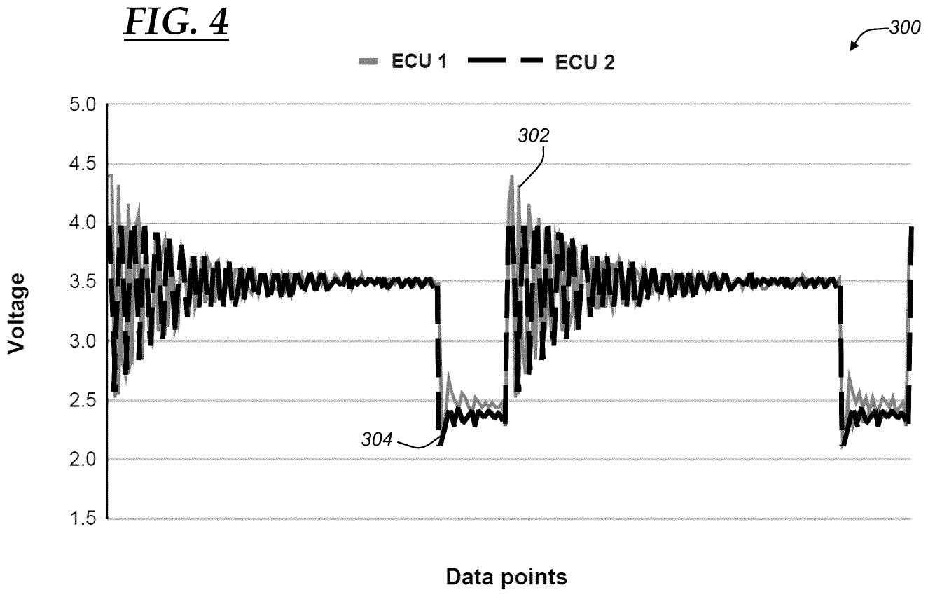

FIG. 4 is a voltage time-series graph 300 illustrating two data transmission signals 302, 304, each one being from a different ECU, such as ECU 102 and ECU 104. The voltage time-series graph 300 depicts voltage measurements taken over a period of time (labelled “Data points” in FIG. 4). As shown, this graph 300 illustrates inherent variations in voltage, which may be introduced in the design, fabrication, and manufacturing process, and this is true even with two of the same devices having all of the same specifications and made at the same facility. Although using aspects of the physical layer have been used for identification of senders in connected networks for many years, this approach exploits sight variations in its output analog signal (referred to as data transmission signal) for identification of the sender, and further implements selective sampling of the data transmission signal, which is discussed below.

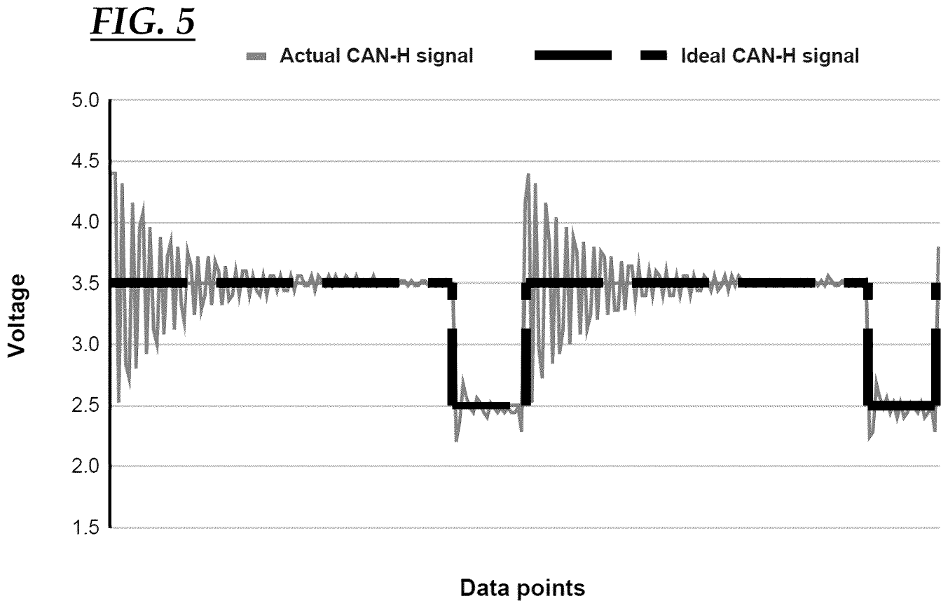

The above mentioned inherent variation of the CAN transmitter may be used to fingerprint the transmitter, as it is unique. FIG. 5 shows how a CAN signal stays in an ideal condition and how it distorts in the real world. The spikes from the ideal line is considered as an impurity or distortion of each CAN transmitter. According to embodiments, the system and method uses such impurities or distortions to create a unique signal characteristic profiling for each transmitter and this may be referred to as the “signature”.

Below is a discussion on how to extract the distortions of the analog signal. It is assumed V is a collection of analog voltage signal captured from the CAN-H wire where:

$$V = ( {V}_{1} , {V}_{2} , {V}_{3} … {V}_{n} ) \qquad Equation ( 1 )$$

Vᵢ should be 3.5 when it is a dominant bit and 2.5 when it is a recessive bit. In real world, the unique artifacts add noise to the ideal value and creates spikes (see 4). In order to extract the unique variations, the spiking points needs to be subtracted from 3.5 or 2.5 depending on it is a dominant or recessive bit. So, the unique artifacts (Distortions, Di) of an ECU is:

$${D}_{i} = ( {V}_{i} - {T}_{j} ) \qquad Equation ( 2 )$$

where Tⱼ is either 3.5 or 2.5 depending on if the bit is dominant or recessive.

With reference back to FIG. 3, the method 200 begins with step 210, wherein distortion data is generated based on the data transmission signal through selectively sampling the data transmission signal. The distortion data is data indicative of signal variances relative to a target signal path, such as variances in voltage relative to a target voltage when taken over time (see voltage time-series graph 300 of FIG. 4). The distortion data is thus data extracted from the data transmission signal, and this data may be used to identify a sender.

In at least some embodiments, the selective sampling includes sampling at a first rate portion of the data transmission signal at a first sampling rate and a second rate portion of the data transmission signal at a second sampling rate that is less than the first sampling rate. The first rate portion corresponds to an information-dense portion and the second rate portion to an information-sparse portion, at least in embodiments. As discussed above, in embodiments, a predetermined overshoot threshold is used to define the first rate portion and the second rate portion, particularly the information-dense portion and the information-sparse portion, respectively, according to embodiments. The predetermined overshoot threshold is used to determine bounds of the information-dense portion and the information-sparse portion. The predetermined overshoot threshold is represented by an amount of volts that is determined by a technician through observing a rate at which the analog signal is changing a predetermined amount (measured in percentage or volts) about the target voltage. An overshoot portion begins when the signal changes from low to high or from high to low. An “overshoot portion” corresponds to the information-dense portion where the predetermined overshoot threshold is used to set the bounds of the overshoot portion.

According to embodiments, the information-sparse portion of the data transmission signal is sampled at an information-sparse sampling rate that is less than an information-dense sampling rate used to sample the information-dense portion. For example, according to embodiments, the information-sparse sampling rate is one-half or less the information-dense sampling rate; and, according to some embodiments, the information-sparse sampling rate is one-fifth or less the information-dense sampling rate. The method 200 continues to step 220.

Because the amount of data to be processed for generating each image has a larger influence on the required computing power, a major goal is to reduce the required amount of sampling points.

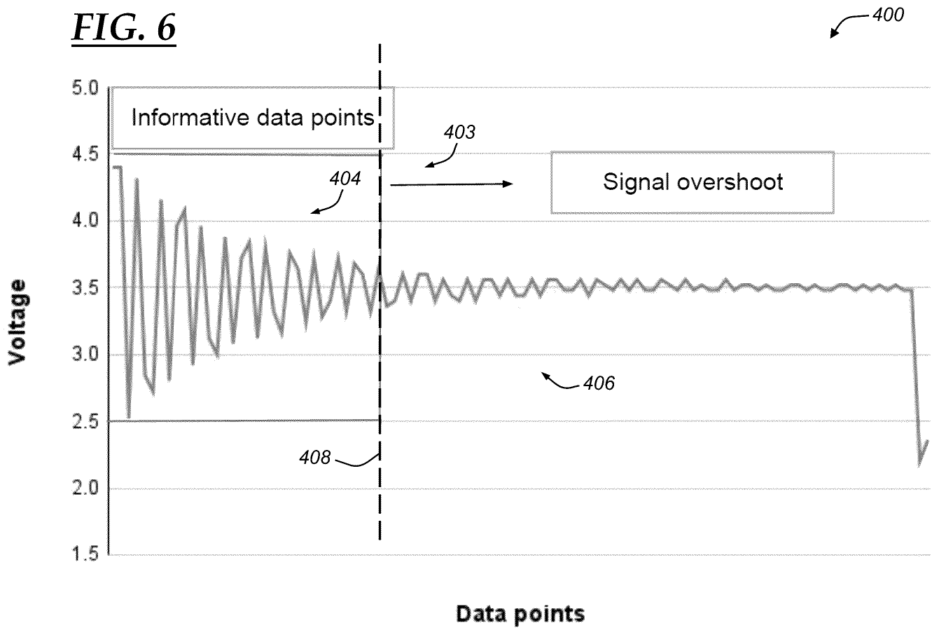

FIG. 6 depicts a voltage time-series graph 400 of voltage measurements of a data transmission signal 402, whereby the data transmission signal 402 is divided (on the basis of time or is said to be “temporally divided”, as used herein) into information-dense portion 404 and an information-sparse portion 406. The information-dense portion 404 and the information-sparse portion 406 are temporally divided by a predetermined overshoot threshold 408. In the present embodiment for a CAN-based communications network, a selective sampling configuration process is used to determine which portions of a data transmission signal are rich with information relative to other portions (referred to as information-sparse portion).

To reduce the sampling points considered to create the image, an experiment with rigorous analysis is conducted. If we look carefully, the backbone of the methodology is the images which are created from the distortions of the ECUs. Again, the distortions are created from analog voltage signal of the CAN signals. In embodiments, portions of a data transmission signal are analyzed to determine which portions are denser in terms of observable variations that contribute to a recurring uniqueness of the data transmission signal. Then, the portions of the data transmission signal are divided into information-dense and information-sparse portions. Next, selective sampling parameters for use in selective sampling (when used in production, for example) are determined based on performing a sender identification method whereby the distortion data is generated according to differing or varying sampling rates, such as the truncated sampling rate, the custom odd sampling rate, and the fifth sequence sampling rate, as discussed below. An example of a selective sampling configuration process is discussed below with reference to FIG. 6.

In FIG. 6, it is clearly visible that the signal 402 has spikes at the beginning and gradually it settles down in terms of voltage. From that, it is inferred that distortions extracted from an overshoot portion 403 of the analog signal 402 holds significant unique information which is very useful in sender identification and, accordingly, at least in this embodiment, the overshoot portion 403 corresponds to the information-dense portion 404 and points outside of the overshoot portion 403 here correspond to an information-sparse portion. In the depicted embodiment, the selective sampling is performed on the basis of which portions of a signal hold rich (information-dense) information and which do not (information-sparse)—such selective sampling on the basis of information saliency is referred to herein as “information-aware” selective sampling. Separating the signal into two portions may be performed by separating two portions of the same bit, such as that shown in the example of FIG. 6.

Determination of the information saliency of portions of a signal may be performed using a test or experimental setup, such as the one described below. In the present embodiment, based on the observation above regarding the overshoot portion, a selective sampling configuration process was conducted in order to determine selective sampling parameters. In this selective sampling configuration process, multiple images are generated based on distortion data from one or more data transmission signals, where the generated images use distortion data that is sampled at varying rates, such as the three rates discussed more below.

In the present exemplary embodiment, a simulation was designed where images generated by three approaches are tested against MobileNetV2 model and the validation accuracy are evaluated. The types of sampling used in the present embodiment are (1) truncated sampling, which is when images are generated using all the information-dense points; (2) custom odd sampling, which is when images are generated using the information-dense points and the odd (every other) sampling points of information-sparse portions; and (3) 5th sequence sampling, which is when images are generated using all the information-dense sampling points and every fifth (e.g., 5th point, 10th point) information-sparse sampling point. The distortion images (generated based on the distortion data) are evaluated (e.g., through feeding the distortion images into a MobileNetV2 model), and are then assessed, such as in terms of validation accuracy and processing time (as shown in the table below), and selective sampling parameters are determined based on the comparison. For example, as discussed in the present embodiment, fifth sequence sampling proved to have a highest accuracy while not being drastically slower than the other truncated sampling, which was a 0.1 ms faster in the present embodiment that was implemented experimentally. Thus, the selective sampling configuration process is used to determine selective sampling parameters usable, for example, by the method 200 for generating the distortion data.

TABLE 3
Performance analysis on information aware down sampling

| Sampling method | Accuracy (%) | Processing time (ms) |
|---|---|---|
| Truncated sampling | 94.21 | 0.04 |
| Custom odd sampling | 95.05 | 0.06 |
| 5th sequence sampling | 98.34 | 0.05 |

With reference back to FIG. 3, the method 200 continues to step 220, wherein a sender of the data transmission signal is identified based on the distortion data. According to embodiments, an ECU (or sender) is uniquely identifiable through recurring patterns in signals the ECU transmits. According to embodiments, the distortion data is transformed into an image that represents a unique pattern of the sender, which is data representing correlations between distortions in a data transmission signal. According to embodiments, techniques that consider the problem as an image classification problem may be used in order to generate a sender signature, which is information that is generated based on the extracted distortion data and that uniquely identifies the sender.

As discussed in the background, while conventional sender identification frameworks offer high percentage of accuracy, the core architecture of these methods depend on handcrafted feature engineering and is computationally costly. As such approaches rely on neural network based methods, the feature engineering remains an essential step in testing phase of the framework. In some cases, the feature engineering becomes computationally so expensive, that the real time sender identification remains a challenge. Additionally, a significant amount of data is required for training neural networks, and obtaining sufficient data poses a challenge for automotive platforms with limited resources. Therefore, the high cost of feature engineering and the limited availability of training data, specifically physical voltage signals, are the primary factors hindering the application of deep learning in physical fingerprinting research for in-vehicle automotive purposes. Hence, at least according to embodiments, the system and method aims to identify the sender of the CAN message using a computationally-affordable approach that employs deep neural networks.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of determining an identity of a sender of a message sent over a physical channel, comprising:
generating distortion data based on a data transmission signal sent over a physical channel through selectively sampling the data transmission signal, wherein selectively sampling the data transmission signal includes sampling the data transmission signal at a first sampling rate and sampling the data transmission signal at a second sampling rate that is different than the first sampling rate; and
identifying a sender of the data transmission signal based on the distortion data.

2. The method of claim 1, wherein first portion sampled data is generated based on the data transmission signal through sampling the data transmission signal at the first sampling rate, wherein second portion sampled data is generated based on the data transmission signal through sampling the data transmission signal at the second sampling rate, and wherein the distortion data is generated based on the first portion sampled data and the second portion sampled data.

3. The method of claim 2, wherein the first portion sampled data of the data transmission signal and the second portion sampled data of the data transmission signal each oscillates about a target voltage.

4. The method of claim 3, wherein the first portion sampled data of the data transmission signal is an overshoot portion of a bit of data being conveyed by the data transmission signal.

5. The method of claim 4, wherein the second portion sampled data of the data transmission signal is a portion of the bit of data that the first portion sampled data of the data transmission signal is a part of.

6. The method of claim 2, wherein a first portion of the data transmission signal is sampled at the first sampling rate to obtain the first portion sampled data and is an information-dense portion, and wherein a second portion of the data transmission signal is sampled at the second sampling rate and is an information-sparse portion.

7. The method of claim 6, wherein the second sampling rate is one-half or less the first sampling rate.

8. The method of claim 7, wherein the second sampling rate is one-fifth or less the first sampling rate.

9. The method of claim 1, wherein the first sampling rate is sampled from a portion of the data transmission signal corresponding to a single bit, and wherein the second sampling rate is sampled from the portion or other portion of the data transmission signal corresponding to the single bit.

10. The method of claim 1, wherein the distortion data is used to generate a distortion image, and wherein the sender is identified based on the distortion image.

11. The method of claim 10, wherein the distortion image is a recurrence plot representing recurring patterns observed in data transmission signals transmitted by the sender.

12. The method of claim 11, wherein the recurrence plot is matched to a representative distortion image in order to identify the sender, and wherein the representative distortion image is one of a plurality of predetermined representative distortion images.

13. The method of claim 12, wherein each of the plurality of predetermined representative distortion images corresponds to a separate sender of a plurality of senders including the sender.

14. An electronic control unit (ECU) authentication system, comprising at least one electronic processor and memory storing computer instructions accessible by the at least one processor, wherein the ECU authentication system is configured, as a result of executing the computer instructions using the at least one processor, to:
sample a data transmission signal at a first sampling rate to obtain first portion sampled data;
sample the data transmission signal at a second sampling rate to obtain second portion sampled data, wherein the first sampling rate is different than the second sampling rate; and
identify a sender of the data transmission signal based on the first portion sampled data and the second portion sampled data.

15. An ECU, comprising the ECU authentication system of claim 14, wherein the ECU is a first ECU of a communications network and is configured to receive the data transmission signal via the communications network from a second ECU of the communications network.

16. An electronic control unit (ECU) authentication system for determining an identity of a sender of a message sent over a physical channel, comprising:
a first ECU having at least one processor and memory storing computer instructions;
a second ECU;
a physical channel for carrying a data transmission signal from the second ECU to the first ECU;
wherein the ECU authentication system is configured, as a result of executing the computer instructions using the at least one processor, to:
sample the data transmission signal at a first sampling rate to obtain first portion sampled data;
sample the data transmission signal at a second sampling rate to obtain second portion sampled data, wherein the first sampling rate is different than the second sampling rate; and
identify a sender of the data transmission signal based on the first portion sampled data and the second portion sampled data.

17. A vehicle communications network, comprising the ECU authentication system of claim 16.

18. The ECU authentication system of claim 17, wherein the physical channel is provided by a controller area network (CAN), and wherein the first ECU and the second ECU are installed on a vehicle having a communications network including the physical layer.

19. The ECU authentication system of claim 17, wherein the second ECU has at least one processor and memory storing computer instructions, and wherein the second ECU is configured, when executing the computer instructions of the second ECU using the at least one processor of the second ECU, to:
sample a second data transmission signal at a third sampling rate to obtain third portion sampled data;
sample the second data transmission signal at the fourth sampling rate to obtain fourth portion sampled data, wherein the third sampling rate is different than the fourth sampling rate; and
identify a sender of the data transmission signal based on the third portion sampled data and the fourth portion sampled data.

20. The ECU authentication system of claim 19, wherein the third sampling rate is the same than the first sampling rate, and wherein the second sampling rate is the same as the fourth sampling rate.
